(19) United States
(12) Patent Application Publication
(10) Pub. No.: US 2002/0172747 A1
(43) Pub. Date: Nov. 21, 2002

(54) Self rising dough-containing food product

(75) Inventors: John Brodie, Penndel, PA (US); Amr Shaheed, Manalapan, NJ (US)

Correspondence Address: John Daniel Wood, Esq., RHODIA INC., 259 Prospect Plains Road, CN-7500, Cranbury, NJ, 08512, US

(73) Assignee: RHODIA INC.

(21) Appl. No.: 09/824,335

(22) Filed: Apr. 2, 2001

(51) Int. Cl. A21D 2/00

(52) U.S. Cl. 426/551

(57) ABSTRACT

A self-rising dough-containing food product in which a non-yeast containing leavening system is combined with an uncooked dough in the presence of a moisture retention agent to provide a frozen food product that may be readily cooked in a microwave oven.

### FIELD OF THE INVENTION

The present invention is directed to a self rising dough-containing food product which contains at least one non-yeast containing leavening agent and is made in the absence of yeast. The dough-containing food product is self rising in the absence of yeast and is particularly suited for heating in a microwave oven while exhibiting excellent organoleptic properties including taste, chew and mouthfeel.

### BACKGROUND OF THE INVENTION

Frozen food products which can be removed from a freezer and then immediately heated have become extremely popular food products. Such products are generally easy to prepare because they are readily removed from the freezer, heated and served in a relatively short period of time without special preparations. Especially popular food products of this type are those which can be heated in a microwave oven, particularly because microwave ovens have become readily available and are easy to use.

One of the more popular specialty food products which are available for microwave heating are those which contain dough and yeast. The food product is precooked, packaged in a frozen condition and then can be prepared for serving by heating in a microwave oven. Particular examples of such products include bakery products and especially pizza. Frozen pizza products contain yeast to provide a thick crust upon heating in the precooking stage. The yeast acts as a leavening agent and upon heating emits a sufficient amount of carbon dioxide to raise the dough to an acceptable level during precooking. The precooked product is then frozen and may then be microwaved or heated in an oven prior to serving.

In order to provide a food product suitable for microwave cooking, it is known to pre-bake the food product and then to freeze the food product prior to packaging. For example, U.S. Pat. No. 4,283,424 discloses a frozen pizza product particularly adapted for cooking and/or reheating in a microwave oven in which the crust comprises first and second crust elements with the first crust element comprised of a baked cracker-type dough material and a second crust element comprising a baked bread dough-type crust. Each of the crust elements is pre-baked prior to packaging the food product.

U.S. Pat. No. 4,957,750 discloses leavened baked goods which when warmed or heated in a microwave oven retain their palatability. A protein-modifier is incorporated into the baked goods which is said to improve the texture of the product.

Pre-baking food products which are intended to be frozen and then heated in an oven or a microwave oven, is a costly step in the preparation of the food product. Pre-baking expends significant sums of energy which adds to the cost of the food product and makes the processing operation time consuming. It would therefore be a significant advantage in the art of making frozen food products to eliminate the pre-baking step.

Food products such as bakery goods and pizza typically contain yeast as a leavening agent. The leavening agent reacts to form carbon dioxide which makes the food product rise when the consumer heats the product. While yeast is an effective leavening agent, it is known that yeast tends to limit the shelf-life of a food product, typically about two months. Frozen food products and other products may therefore have to be discarded prior to sale if the shelf-life is limited by the presence of yeast as a leavening agent.

In recent years, chemical leavening agents have been incorporated into conventional frozen bakery products including frozen pizza. See Thomas A. Lehmann et al. Cereal Foods World, Vol. 25, No. 9 (September 1980) pp. 589-592; Lallemand Inc. Baking Update *1996); K. Skruland Baking Management (October 1998) pp. 40-41; and Thomas A. Lehmann, Am. Inst. Of Baking Vol. XIX (November 1997) pp. 1-6. Such chemical leavening systems require the generation of carbon dioxide and employ, for example, sodium bicarbonate as one of the components of the chemical leavening system along with a leavening acid such as sodium aluminum phosphate, sodium acid pyrophosphate and the like.

The dough containing the chemically leavening agent is typically precooked and frozen soon after forming. Under these circumstances, it is not uncommon for pizza products to have a shelf-life up to and perhaps exceeding six months.

Frozen bakery products including pizza have gained increasing acceptance in the marketplace. Typical formulations, however, are not suitable for heating in a microwave oven and it is therefore recommended that such products be oven baked. Typical food preparation instructions call for baking pizza in an oven, typically preheated, at a baking temperature of from about 350 to 450° F.

As is well known baking in an oven often takes 15 to 30 minutes while microwave cooking can typically be accomplished in significantly less time, typically about 3 to 4 minutes. However, the frozen products described above do not lend themselves to microwave cooking because the crust tends to become soggy and there is often uneven cooking.

It is therefore desirable to provide a frozen food product which has a commercially acceptable shelf life and which does not have to be precooked. It is also desirable to provide a frozen food product which employs a chemically leavening agent and which can be heated in a microwave by the consumer. It is also desirable to provide a self rising pizza dough which if heated in a microwave has similar organoleptic properties including desirable taste, chew and mouthfeel to conventional oven baked pizza products. It is still also desirable to provide a frozen food product which may be heated in a microwave by the consumer and which does not require pre-cooking prior to packaging.

### SUMMARY OF THE INVENTION

The present invention is generally directed to a self rising dough containing food product which does not require pre-cooking and eliminates yeast as a principal leavening agent. Such food products can be frozen and stored for extended periods of time and can be readily cooked using conventional and microwave ovens. The resulting food products have desirable oganoleptic properties including taste, chew and mouthfeel typically associated with precooked frozen food products that require cooking by the consumer in a conventional oven.

In a particular aspect of the present invention, there is provided a self rising dough-containing food product comprising:

a) an uncooked dough;

b) at least one non-yeast containing leavening agent;

c) a material capable of reacting with the non-yeast containing leavening agent to generate a sufficient amount of carbon dioxide to make the dough rise to a desirable level;

d) an effective amount of a moisture retention agent to retain sufficient moisture in the dough during heating to provide the resulting heated product with desirable organoleptic properties.

### DETAILED DESCRIPTION OF THE INVENTION

The self rising dough containing food product of the present invention includes a conventional dough material which is not pre-cooked. All standard dough systems and dough materials may be employed the present invention. Typically, by way of example, the dough will be made from wheat flour, preferably high protein flour, non-fat milk solids, with the optional addition of soy protein concentrate and other conventional additives. The composition of the dough may vary depending on the final product.

In accordance with one aspect of the present invention, the dough material is provided with at least one non-yeast containing leavening agent as the principal leavening agent. The minimal use or preferably elimination of yeast enables the dough-containing product to assume an extended shelf-life because of the tendency of yeast to degrade in a relatively short period of time. A shelf-life of up to and exceeding one year is possible by the frozen food product of the present invention. In general, the principal leavening agents employed in the present invention and preferably the only leavening agents are non-yeast containing leavening acids such as sodium aluminum phosphate leavening acid produced by Rhodia Inc. under the brand name Levair. The amount of the leavening agent for use in the present invention will typically be in the range of at least 0.40% based on the weight of flour and preferably from about 0.40 to 1.20% by weight based on the weight of the flour. Other non-yeast containing leavening agents which may be used in the present invention include calcium phosphate and sodium acid pyrophosphate leavening acid.

The non-yeast containing leavening agents employed in the present invention react with a compound capable of generating carbon dioxide to enable the dough to rise to a desirable level. Desirable carbon dioxide generating compounds which react with the non-yeast containing leavening agent include sodium bicarbonate, and potassium bicarbonate and ammonium bicarbonate.

The dough-containing food product of the present invention also contains a moisture retention agent which enables the food product to maintain a moisture content sufficient to provide a soft, desirable texture to the product after heating so as to provide excellent organoleptic properties including taste, chew and mouthfeel. Various food grade gums may be used for this purpose including xanthan gum. A particularly preferred xanthan gum is Rhodigel Ultra of Rhodia, Inc.

The moisture retention agent is preferably employed in an amount of from 0.05% by weight to 0.135% by weight based on the total weight of flour present in the food product.

The present invention may also contain a dough conditioner which serves to break down the bonds of the dough and thereby make it softer. Dough conditioners are also known in the art as protein modifiers which are able to break the bonds of the gluten structure contained in a wheat product. Examples of dough conditioners include L-cysteine and salts thereof. A particularly preferred dough conditioner contains sodium stearoyl lactylate, calcium sulphate and L-cysteine hydrochloride. The amount of the dough conditioner is typically present in an amount of from about 0.5 to 1.0% by weight based on the weight of the flour in the food product.

When making a frozen pizza product it is also desirable to make the frozen product no greater than about ¼ inch, typically about ⅛ inch thick in order to facilitate uniform heating of the frozen product especially in a microwave oven.

In addition, the heating of the frozen food product of the present invention in a microwave oven is best carried out by elevating the food product above the floor of the microwave oven. Susceptor disks commonly used in microwave ovens may be used for this purpose.

### EXAMPLE 1

### Preparation Of Self Rising Pizza Product

The ingredients listed in Table 1 were employed to form a pizza product in accordance with the present invention.

TABLE 1

| Ingredients | Bakers % |
|---|---|
| Wheat Four | 100.00 |
| Non Fat Milk Solids | 2.50 |
| Defatted Soy Protein Concentrate | 2.07 |
| Dextrose | 2.00 |
| Salt | 1.79 |
| Olive Oil | 2.50 |
| Shortening, All Purpose | 2.25 |
| Baking Soda, Fine Granular | 0.81 |
| Levair (SALP) | 0.81 |
| Panicrust LC-K (Brand Name) | 0.75 |
| Rhodigel Ultra | 0.09 |
| Water | 62.50 |
| Total | 178.07 |

A Hobart M-50 mixer equipped with a five quart bowl and dough hook was used to mix the dry ingredients set forth in Table 1. Mixing was continued until all of the ingredients were well dispersed either by blending or sifting. Thereafter, shortening (partly containing olive oil), oil and water were added to the vessel while mixing proceeded at a low speed for two minutes. The ingredients were then mixed in the same vessel at a medium speed for one and a half minutes to produce a dough product.

### EXAMPLE 2

### Formation Of Microwavable Pizza Product

The dough produced in accordance with Example 1 was formed into 150 g round samples which is typically sufficient to form a ¼ inch thick pizza product having a diameter of 6 to 7 inches. The samples were allowed to remain at rest for 10 to 15 minutes. A roller was used to roll out the samples to a 7 inch diameter. The product was frozen and each frozen product was provided with 25 g of tomato sauce and 25 to 50 g of cheese. The entire product was frozen until all of the ingredients including the toppings were frozen and the frozen product was packaged and kept in the freezer.

### EXAMPLE 3

### Cooking Of Frozen Pizza Product

The frozen pizza product produced in Example 2 was placed on a susceptor disk and placed on a box in a microwave oven. The pizza product was cooked for 3½ to 4 minutes on full power and thereafter removed from the oven. The pizza product had desirable organoleptic properties including taste, chew and mouthfeel.

Alternatively, the frozen pizza product can be placed in a conventional oven with or without preheating to a temperature of about 450° F. until the baking operation is complete.

What is claimed:

1. A self rising dough-containing food product comprising:
a) an uncooked dough;
b) at least one non-yeast containing leavening agent;
c) a material capable of reacting with the non-yeast containing leavening agent to generate a sufficient amount of carbon dioxide to make the dough rise to a desirable level; and
d) an effective amount of a moisture retention agent to retain sufficient moisture in the dough during heating to provide the resulting heated product with desirable taste and chew properties.

2. The food product of claim 1 in which the entire amount of the leavening agent is a non-yeast containing leavening agent.

3. The food product of claim 1 further comprising a dough conditioner.

4. The food product of claim 1 in which the leavening agent is a sodium acid phosphate leavening acid.

5. The food product of claim 1 wherein the moisture retention agent is a gum.

6. The food product of claim 5 wherein the moisture retention agent is xanthan gum.

7. The food product of claim 1 wherein the material capable of reacting with the leavening agent is a bicarbonate.

8. The food product of claim 7 wherein the bicarbonate is sodium bicarbonate.

9. The food product of claim 1 in the form of a frozen pizza.

10. The food product of claim 9 which is microwaveable.

11. A method of producing a self rising dough-containing food product comprising:
a) forming an uncooked dough product comprising a moisture retention agent; and
b) adding to said uncooked dough product an effective amount of at least one non-yeast containing leavening agent and a material capable of reacting with the non-yeast containing leavening agent to generate a sufficient amount of carbon dioxide to make the dough rise to a desirable level; and
c) freezing the uncooked dough product resulting from step (b).

12. The method of claim 11 wherein the entire amount of the leavening agent is a non-yeast containing leavening agent.

13. The method of claim 12 further comprising heating the uncooked dough product in a microwave oven.

14 The method of claim 12 wherein the self-rising dough containing food product is in the form of a pizza.
